(19) United States
(12) Patent Application Publication
(10) Pub. No.: US 2018/0285842 A1
(43) Pub. Date: Oct. 4, 2018

(54) SELF-SERVICE KIOSK DEVICES AND SYSTEMS AND METHOD FOR OPERATION THEREWITH

(71) Applicant: NCR Corporation, Duluth, GA (US)

(72) Inventor: Vishwam Guntupalli, Duluth, GA (US)

(21) Appl. No.: 15/474,260

(22) Filed: Mar. 30, 2017

(51) Int. Cl. G06Q 20/10; G07D 11/00

(52) U.S. Cl. CPC G06Q 20/1085; G07D 11/0036

(57) ABSTRACT

Various embodiments herein each include at least one of systems, devices, methods, and software for self-service kiosk devices and systems and for the operation therewith. One embodiment, in the form of a method, includes receiving input defining a transaction with regard to an account to be conducted at a self-service kiosk device and staging the transaction defined by the received input. This method further includes receiving a notification that an authentication with regard to the account has been received from a particular self-service kiosk device and transmitting a set of commands to the particular self-service kiosk device to perform the staged transaction.

### BACKGROUND INFORMATION

Self-service kiosks today, while technically more advanced than when they first introduced, provide much the same user experience as when they were first introduced. The user experience begins with a user tendering a bankcard, entering a Personal Identification Number (PIN), entering the transaction details, receiving currency or tendering a deposit, and then receiving a receipt and return of the card, if it was held during the transaction. Recent advancements have added touchscreens and quick transaction options, but the user experience is much the same. Banking customers often desire to conduct their transactions more quickly and in ways that are more personal to them.

### SUMMARY

Various embodiments herein each include at least one of systems, devices, methods, and software for self-service kiosk devices and systems and for the operation therewith.

One such embodiment is a device including a controller thereof that is able to communicate over a network, receive commands with regard to its services, and provide those services, such as dispense cash, receive a deposit, and print a receipt. Some such embodiments operate by providing an interface that banks communicate with to issue commands to and receive feedback from such kiosk devices. The kiosk devices, in some such embodiments, do not include operating systems, but rather just firmware and software for their simple operation when compared to traditional automated teller machines (ATMs). In some such embodiments, a banking customer interacts with the bank to stage a transaction to be performed at such as kiosk device via a smartphone app, such as a mobile banking app. The app is used to define what will be performed in the transaction, such as a cash withdrawal, and when the customer arrives at a particular kiosk device, the customer's presence is communicated either director or indirectly to the kiosk device and the transaction is performed.

Another embodiment, in the form of a method, includes receiving input defining a transaction with regard to an account to be conducted at a self-service kiosk device and staging the transaction defined by the received input. This method further includes receiving a notification that an authentication with regard to the account has been received from a particular self-service kiosk device and transmitting a set of commands to the particular self-service kiosk device to perform the staged transaction.

Another method embodiment includes receiving input on a mobile device within an app defining a transaction to be completed at a self-service kiosk device and transmitting data of the received input over a network to stage the transaction. The data may be transmitted to a self-service kiosk for staging or to a server that stages the data until a self-service kiosk on which the transaction is to be conducted is identified. The method of this embodiment may then receive, within the app, an identifier of a self-service kiosk device of where the staged transaction is to be completed and transmitting the identifier of the self-service kiosk device over the network to initiate fulfillment of the transaction.

A further embodiment is in the form of a system. The system in this embodiment includes a network interface device, a processor, and a memory device storing instructions executable by the processor to perform data processing activities. The data processing activities may include receiving, via the network interface device, input defining a transaction with regard to an account to be conducted at a self-service kiosk device and staging, on the memory device, the transaction defined by the received input. The data processing activities may further include receiving an instruction to complete the transaction and an identifier of a particular self-service kiosk device on which the transaction is to be completed. The data processing activities also include transmitting a set of commands to the particular self-service kiosk device to perform the staged transaction.

### BRIEF DESCRIPTION OF THE DRAWINGS

FIG. 1 illustrates a system architecture according to an example embodiment

FIG. 2 is an entity flow diagram of a method, according to an example embodiment.

FIG. 3 is an entity flow diagram of a method, according to an example embodiment.

FIG. 4 is a logical block flow diagram of a method, according to an example embodiment.

FIG. 5 is a logical block flow diagram of a method, according to an example embodiment.

FIG. 6 is a block diagram of a computing device, according to an example embodiment

### DETAILED DESCRIPTION

Various embodiments herein each include at least one of systems, devices, methods, and software for self-service kiosk devices and systems and for the operation therewith.

One such embodiment s a device including a controller thereof that is able to communicate over a network, receive commands with regard to its services, and provide those services, such as dispense cash, receive a deposit, and print a receipt. Some such embodiments operate by providing an interface that banks communicate with to issue commands to and receive feedback from such kiosk devices. The kiosk devices, in some such embodiments, do not include operating systems, but rather just firmware and software for their simple operation when compared to traditional automated teller machines (ATMs). In some such embodiments, a banking customer interacts with the bank to stage a transaction to be performed at such as kiosk device via a smartphone app, such as a mobile banking app. The app is used to define what will be performed in the transaction, such as a cash withdrawal, and when the customer arrives at a particular kiosk device, the customer's presence is communicated either director or indirectly to the kiosk device and the transaction is performed. Deposits, withdrawals, and other possible transactions can be performed in such a manner.

The customer's presence at a kiosk device may be determined in several ways. In a simple embodiment, a user may simply input on their mobile device that they are ready to conduct the transaction. Some such embodiments may add a security layer on top of that to confirm the customer is located at or proximate to the kiosk device. This may include use of a BLUETOOTH™ beacon device, a broadcast radio signal from a radio device of or located proximate the kiosk device, use of global positioning system (GPS) data from a mobile device, WI-FI® locating services, and other locating services.

Transactions may be staged for performance at such a kiosk device through a mobile device app in communication with a banking system. The banking system may communicate directly with a kiosk device where the transaction is to be conducted or via a service provider. The service provider, in some embodiments, may provide an application programming interface (API) that enables the banking system to communicate as if the service is an automated teller machine. The service then handles communication with the kiosk device. When the transaction has been completed on the kiosk device, the service receives confirmation thereof, or of failure if that is the case, and relays the success or failure message to the banking system.

These and other embodiments are described herein with reference to the figures.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

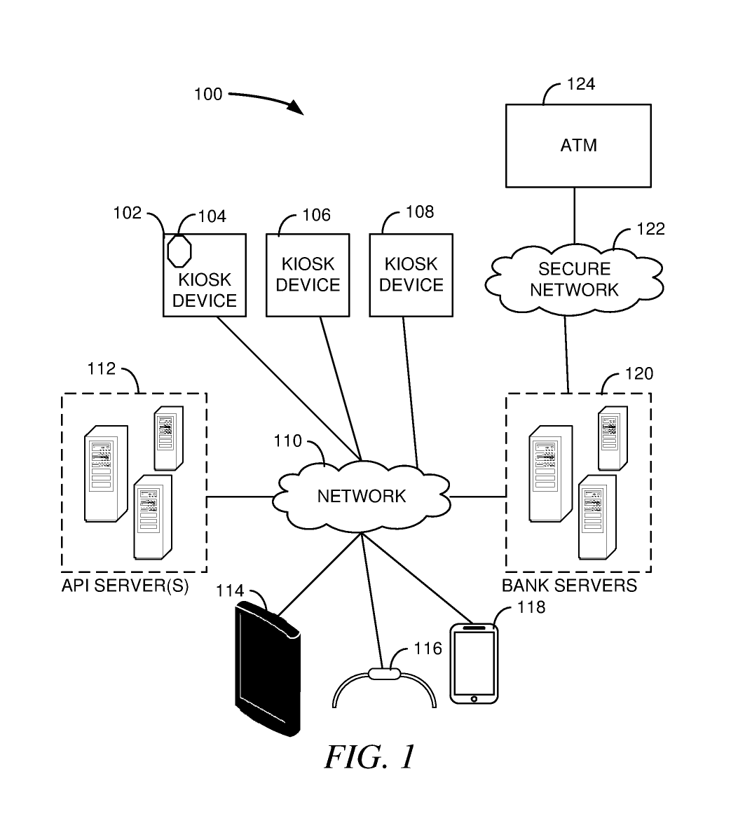

FIG. 1 illustrates a system 100 architecture according to an example embodiment. The system 100 includes a plurality of self-service kiosk devices 102, 106, 108 through which customers can conduct transactions, such as transactions that are traditionally performed at ATMs. The kiosk devices 102, 106, 108 are connected to a network 110, such as the Internet, a dedicated, proprietary network, or other network. Also connected to the network 110 is an API server 112 of a service provider than enables bank servers 120 that are connected to the network 110 to communicate with the kiosk devices 102, 106, 108 as if they are ATMs, but instead the API server 112 is a proxy for the kiosk devices 102, 106, 108. The bank servers 120 may also be connected to a secure network 122, such as is common for use in communicating with ATMs, such as ATM 124. As such, some embodiments may also enable customers to access the ATM 124 as if it were a kiosk device 102, 106, 108 thereby modernizing transaction capabilities of the ATM 124. Lastly, mobile devices, such as a tablet 114, a smartwatch 116, and a smartphone 118, may also be connected to the network 118.

In operation, a banking customer may desire to make a cash withdrawal from a bank account at the ATM 124 or a kiosk device 102, 106, 108. The customer may use their mobile device, such as smartphone 118, to access a mobile banking app thereon, authenticate, select the account, and chose an option to define a withdrawal transaction, such as a withdrawal amount and a location where the withdrawal is to be made. However, not all transactions need to have a location defined as that can be input later or sensed in some embodiments when the smartphone 118 or other mobile device is in proximity to a kiosk device 102, 106, 108 or the ATM 124. The mobile banking app may provide an option for the customer to search for a location where the transaction can be completed. Also note that the mobile device app may actually be a website that may also be accessed from a personal computer.

Once the transaction is defined, data defining the transaction may be transmitted from the smartphone 118 over the network to the bank servers 120. The bank server 120 may then stage the transaction, which may include transmitting the data to the API server 112 over the network 110 (as illustrated) or over the secure network 122 when the API server is instead or also connected to the secure network 122. The transaction is staged such that when notification is received that the smartphone 118 is located at a kiosk device 102, 106, 108 or the ATM 124 the staged transaction can be completed by issuing currency in amount of the staged transaction. The kiosk deice 102, 106, 108 or ATM may dispense the currency in response to a command received from the API server 112 or the banking servers 120. The command may be received following a message from the smartphone 118 app to the API server 112 or bank servers 120 in response to the customer providing input requesting dispensing of the currency. The command to dispense currency may also include a data item identifying the location or machine to dispense the currency or to confirm the customer is proximate to the appropriate machine that will dispense the currency. That data item may be a code decode from an a barcode (e.g., QR code) captured by the smartphone 118 from the kiosk device 102, 106, 108 or ATM 124, a GPS or other locating coordinate set or data element, a unique BLUETOOTH® beacon 104 identifier or other radio device identifier that may be broadcast by a kiosk device 102, 106, 108 or the ATM 124 or device co-located therewith or other location or machine specific dataset.

Once the kiosk device 102, 106, 108 or ATM 124 has dispensed the currency or the dispensing failed, a return is provided to the API server 112 or the bank servers 120 from which the dispense command was received. The API server 112 relays this message back to the bank servers 120. A message may also be transmitted by to the smartphone 118.

When the transaction is instead a deposit, the kiosk device 102, 104, 108 or ATM 124 where the transaction is conducted instead receives currency and checks from the customer rather than dispensing currency.

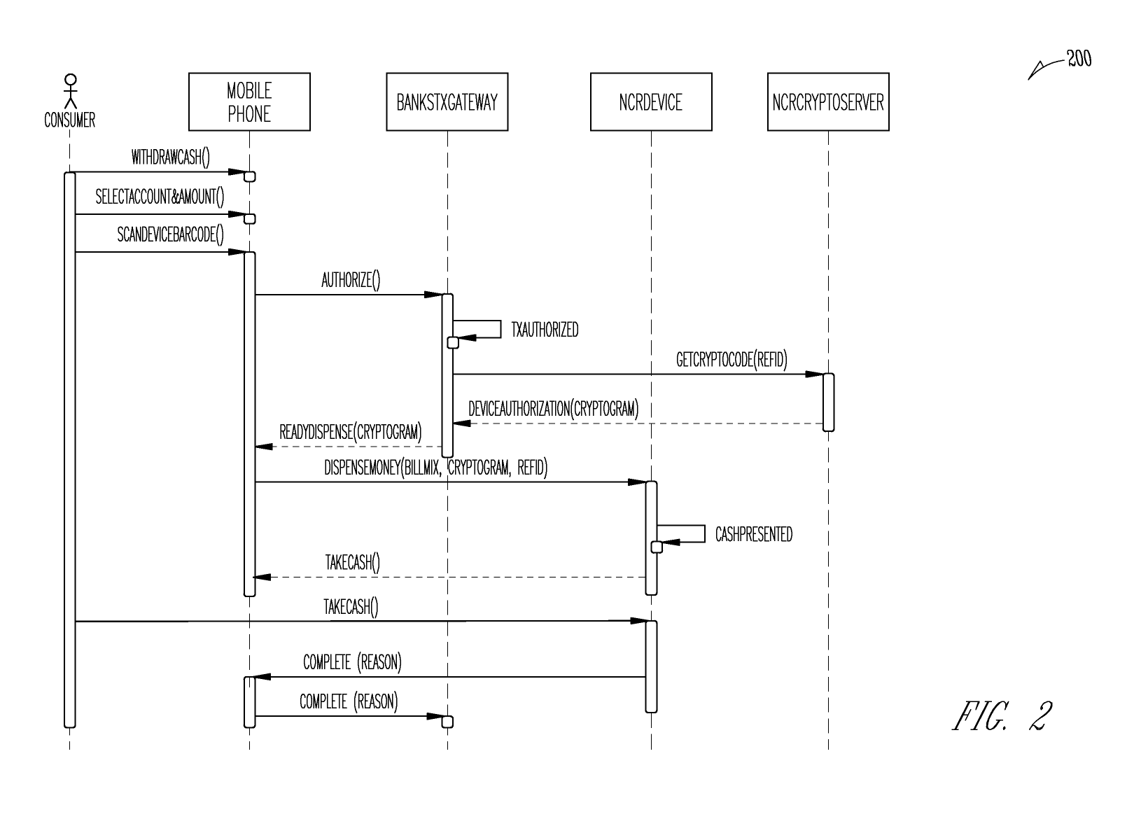

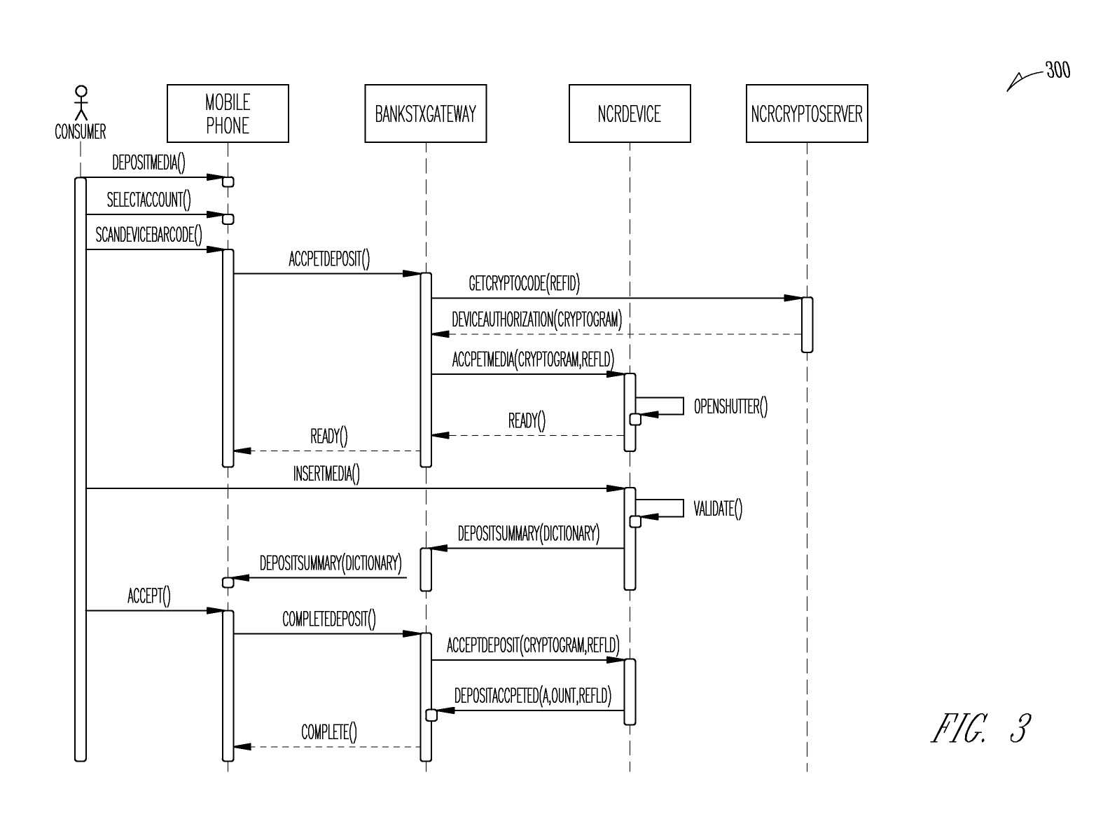

FIG. 2 and FIG. 3 are entity flow diagrams of methods 200, 300, according to example embodiments. The example methods 200, 300 of FIG. 2 and FIG. 3 provide further examples of how transactions are conducted and communications are synchronized to facilitate transaction performance and completion.

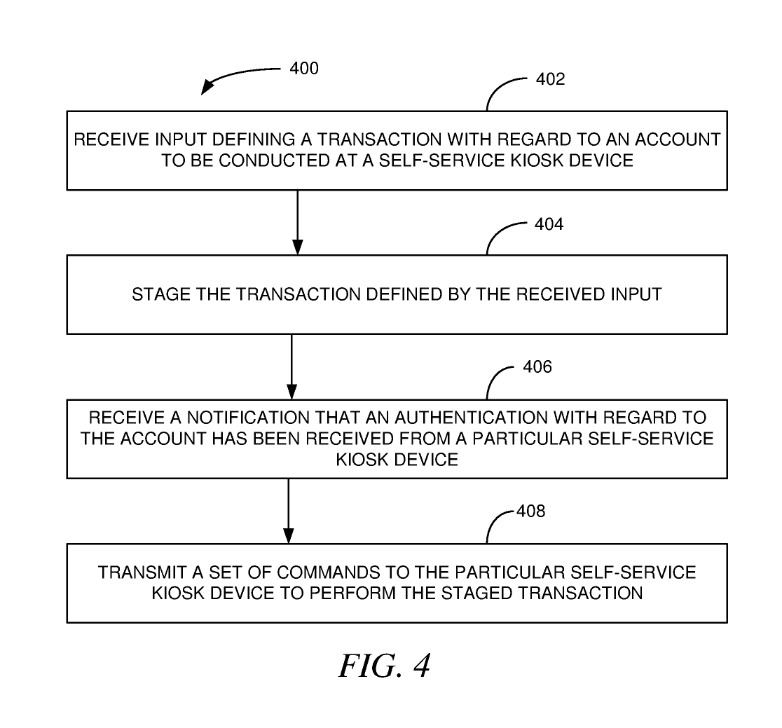

FIG. 4 is a logical block flow diagram of a method 400, according to an example embodiment. The method 400 is an example method that may be performed in whole or in part on one or both of an API server, such as API server 112 of FIG. 1, and a bank server, such as the bank servers 120 also of FIG. 1.

The method 400 includes receiving 402 input defining a transaction with regard to an account to be conducted at a self-service kiosk device and staging 404 the transaction defined by the received input. The method 400 also includes receiving 406 a notification that an authentication with regard to the account has been received from a particular self-service kiosk device and then transmitting 408 a set of commands to the particular self-service kiosk device to perform the staged transaction.

In some embodiments, the self-service kiosk device does not include any devices to receive direct human input. However, in other embodiments, the particular self-service kiosk device is an ATM.

In some embodiments of the method 300, the received 402 input defining the staged 404 transaction includes a cash withdrawal from a bank account. In some instances, the self-service terminal is a standalone cash dispensing device. In one such embodiment, receiving 406 the notification the authentication with regard to the account has been received includes receiving a token from a mobile device app on which an account has been authenticated. This token may have been received by the mobile device app from the standalone cash dispensing device in some embodiments. The method 400 in some such embodiments may then transmit an instruction to be presented within the mobile device app instructing the user to perform an action to take the cash when dispensed. In some of these embodiments, the token is a unique identifier transmitted by a radio device of the standalone cash dispensing device, such as the BLUETOOTH® beacon device 104 associated with the kiosk device 102 of FIG. 1.

In some additional embodiments of the method 400, the received 4-2 input defining the transaction is received over a network from a computer system of a bank that maintains the account. The method 400 in some such embodiments also includes receiving a confirmation from the self-service kiosk device that the transaction was completed successfully and transmitting a confirmation to a system of the bank that the transaction was completed successfully.

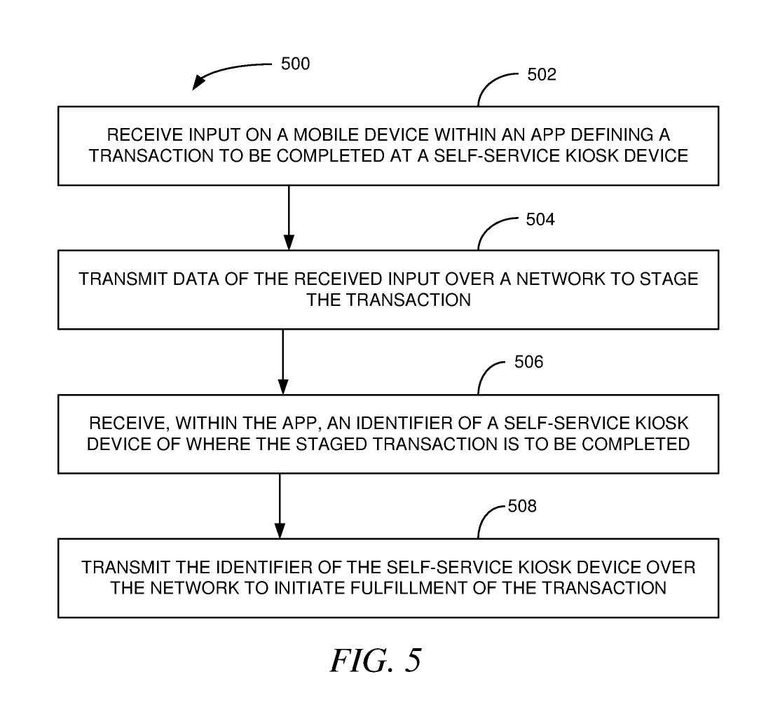

FIG. 5 is a logical block flow diagram of a method 500, according to an example embodiment. The method 500 is a method that may be performed in whole or in party by a mobile device app that executes on a mobile deice, such as smartphone 118, smartwatch 116, or tablet 114 of FIG. 1. Note that in some embodiments, the mobile device may be a smart controller of an automobile, such as an in-vehicle informaion system that includes a mobile banking app or web browser that executes thereon and through which mobile banking services may be accessed.

The method 500 includes receiving 502 input on a mobile device within an app defining a transaction to be completed at a self-service kiosk device. The method 500 may then transmit 504 data of the received input over a network to stage the transaction. The method 500 may then receive 506, within the app, an identifier of a self-service kiosk device of where the staged transaction is to be completed. Fulfillment of the transaction may then be initiated in some embodiments by transmitting 508 the identifier of the self-service kiosk device over the network.

In some embodiments of the method 500, the identifier of the self-service kiosk device is transmitted over the network along with location-confirming data to confirm the mobile device is in proximity to the self-service kiosk device.

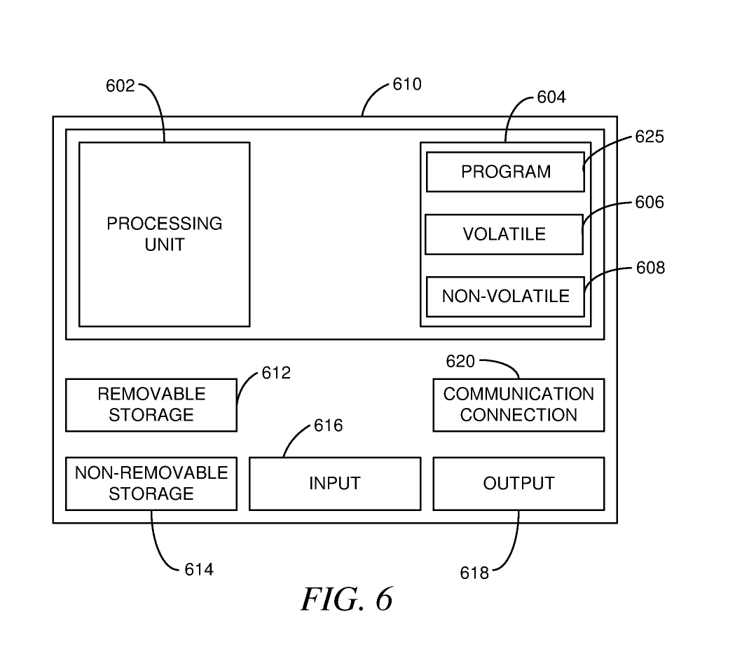

FIG. 6 is a block diagram of a computing device, according to an example embodiment. In one embodiment, multiple such computer systems are utilized in a distributed network to implement multiple components in a transaction based environment. An object-oriented, service-oriented, or other architecture may be used to implement such functions and communicate between the multiple systems and components. One example computing device in the form of a computer 610, may include a processing unit 602, memory 604, removable storage 612, and non-removable storage 614. Memory 604 may include volatile memory 606 and non-volatile memory 608. Computer 610 may include—or have access to a computing environment that includes a variety of computer-readable media, such as volatile memory 606 and non-volatile memory 608, removable storage 612 and non-removable storage 614. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 610 may include or have access to a computing environment that includes input 616, output 618, and a communication connection 620. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

In some embodiments, the computer 610 may be a controller of a self-service kiosk device and be rather simple in nature, including fewer than all the elements illustrated in FIG. 6. At the same time, the computer 610 in such self-service kiosk embodiments may include other components, such as a security module, which may include a trusted platform module (TPM) or other module that is implemented to secure operation of the self-service kiosk and communications between the self-service kiosk and other authorized devices. The security module may be hardware, software, or a combination thereof.

Computer-readable instructions stored on a computer-readable medium are executable by the processing unit 602 of the computer 610. A hard drive, CD-ROM, and RAM are some examples of articles including a non-transitory computer-readable medium. For example, a computer program 625 capable of providing a generic technique to perform access control check for data access and/or for doing an operation on one of the servers in a component object model (COM) based system according to the teachings of the present invention may be included on a CD-ROM and loaded from the CD-ROM to a hard drive. The computer-readable instructions allow computer 610 to provide generic access controls in a COM based computer network system having multiple users and servers.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
receiving input defining a transaction with regard to an account to be conducted at a self-service kiosk device;
staging the transaction defined by the received input;
receiving a notification that an authentication with regard to the account has been received from a particular self-service kiosk device; and
transmitting a set of commands to the particular self-service kiosk device to perform the staged transaction.

2. The method of claim 1, wherein the self-service kiosk device does not include any devices to receive direct human input.

3. The method of claim 1, wherein the particular self-service kiosk device is an automated teller machine (ATM).

4. The method of claim 1, wherein the input defining the staged transaction includes a cash withdrawal from a bank account.

5. The method of claim 4, wherein self-service terminal is a standalone cash dispensing device.

6. The method of claim 5, wherein receiving the notification the authentication with regard to the account has been received includes:
receiving a token from a mobile device app on which an account has been authenticated, the token received by the mobile device app from the standalone cash dispensing device; and
transmitting an instruction to be presented within the mobile device app instructing the user to perform an action to take the cash when dispensed.

7. The method of claim 6, wherein the token is a unique identifier transmitted by a radio device of the standalone cash dispensing device.

8. The method of claim 1, wherein the input defining the transaction is received over a network from a computer system of a bank that maintains the account.

9. The method of claim 8, further comprising:
receiving a confirmation from the self-service kiosk device that the transaction was completed successfully; and
transmitting a confirmation to a system of the bank that the transaction was completed successfully.

10. A method comprising:
receiving input on a mobile device within an app defining a transaction to be completed at a self-service kiosk device;
transmitting data of the received input over a network to stage the transaction;
receiving, within the app, an identifier of a self-service kiosk device of where the staged transaction is to be completed; and
transmitting the identifier of the self-service kiosk device over the network to initiate fulfillment of the transaction.

11. The method of claim 10, wherein the identifier of the self-service kiosk device is transmitted over the network along with location-confirming data to confirm the mobile device is in proximity to the self-service kiosk device.

12. The method of claim 11, wherein the location-confirming data is at least one of a global-positioning system (UPS) coordinate set, a unique identifier decoded from a barcode presented at a location of the self-service kiosk device, and a unique identifier of a radio beacon device of or deployed with the self-service kiosk device.

13. The method of claim 10, wherein the input defines a bank account withdrawal and the data transmitted over the network to stage the transaction is transmitted to a bank that maintains the bank account from which the withdrawal is to be made.

14. The method of claim 13, further comprising:
receiving, in response to transmitting the data over the network to the bank to stage the transaction an identifier of a network location of an operator of the self-service kiosk; and
wherein the identifier of the self-service kiosk device is transmitted to the network location of the operator of the self-service kiosk device to initiate the fulfillment of the transaction on the self-service kiosk device.

15. A system comprising:
a network interface device;
a processor; and
a memory device storing instructions executable by the processor to perform data processing activities comprising:
receiving, via the network interface device, input defining a transaction with regard to an account to be conducted at a self-service kiosk device;
staging, on the memory device, the transaction defined by the received input;
receiving an instruction to complete the transaction and an identifier of a particular self-service kiosk device on which the transaction is to be completed; and
transmitting a set of commands to the particular self-service kiosk device to perform the staged transaction.

16. The system of claim 15, wherein:
the command to complete the transaction is received with an additional data item relayed from a mobile device of an authenticated account holder; and
the additional data item is included with the set of commands transmitted to the particular self-service kiosk device.

17. The system of claim 16, wherein the additional data item is an identifier included in a short-range radio signal broadcast by a radio device of or located proximate to the self-service kiosk device.

18. The system of claim 17, wherein the self-service kiosk device includes a cash dispenser and the set of commands transferred thereto includes a command to dispense a certain value of cash.

19. The system of claim 15 wherein the input defining the transaction is received over a network from a computer system of a bank that maintains the account.

20. The system of claim 19, the data processing activities further comprising:
receiving a confirmation from the self-service kiosk device that the transaction was completed successfully; and
transmitting a confirmation to a system of the bank that the transaction was completed successfully.
